(19) United States
(12) Patent Application Publication
(10) Pub. No.: US 2004/0080484 A1
(43) Pub. Date: Apr. 29, 2004

(54) Display devices manufactured utilizing mems technology

(76) Inventors: Amichai Heines, Herzelia (IL); Joseph Shappir, Mevasseret-Zion (IL); Adiel Karty, Zichron-Yaacov (IL); Allon Cohen, Modyin (IL)

Correspondence Address: William H Dipper, Reed Smith, 29th Floor, 599 Lexington Avenue, New York, NY, 10022-7650, US

(21) Appl. No.: 10/432,174

(22) PCT Filed: Nov. 22, 2001
(86) PCT No.: PCT/IL01/01076

(51) Int. Cl. G09G 3/34

(52) U.S. Cl. 345/108

(57) ABSTRACT

Apparatus including a substrate, having a substrate surface; an object having a maximum dimension smaller than 1 mm; an axle, having an axis, attached to the object body; and an axle support attached to the substrate and having a support surface. The axle has a rounded cross-section, as manufactured and forms a non-zero angle with a perpendicular to the surface. The object is capable of rotating about the axle.

### RELATED APPLICATIONS

This application claims the benefit of U.S. Provisional Application No. 60/252,699, filed 22 Nov. 2000. The present application is related generally to PCT application Ser. No. PCT/IL99/00488, filed Sep. 8, 1999 and published as WO 00/52674, PCT/IL99/00130, filed Mar. 4, 1999 and published as WO 99/45423, and PCT application PCT/IL00/00475, filed Aug. 6, 2000, the disclosures of all of which are incorporated herein by reference.

Some of the subject matter of these applications is related to a best mode of carrying out the invention. This should not be construed as limiting the invention to embodiments which utilize all or even some of this matter.

### FIELD OF THE INVENTION

The invention relates to the field of micro-machined devices with particular applicability to displays produced by micro-machining.

### BACKGROUND OF THE INVENTION

Flat-panel video displays are ubiquitous components of many consumer, industrial and military products and devices. They are found in computer laptops, automobile dashboards, microwave ovens and a myriad of other machines and devices with which man interacts.

Active-matrix liquid-crystal displays dominate the market for high quality medium-resolution flat-panel displays. However, these displays are relatively expensive and the amount of power they consume when operating is relatively large in comparison to the amount of power readily available from many battery driven devices.

The need and desire to incorporate visual displays into more and more products, ranging from portable GPS receivers to hand held computers to toys, has created a strong demand and expanding market for inexpensive flat-panel displays that can provide high quality images and operate with low power consumption.

In response to the demand, new types of flat panel displays have been developed based on the processing of silicon using MEMS technology. MEMS technology enables microstructures having features on the order of a few microns to be formed on appropriate silicon or other substrates. The technology can therefore be used to produce “pixel” sized devices, on silicon, that can manipulate light. Arrays of these devices are useable to form flat-panel displays that are potentially inexpensive, that operate with low energy consumption and provide high-quality images.

Most flat-panel displays produced using silicon technology belong to one of two general types. A flat-panel display of a first type has pixels each of which comprises a liquid crystal cell formed on a silicon substrate. Light, which may be ambient light or light from an appropriate light source, illuminates the pixels. Transmittance of the liquid crystal in each pixel for the light determines how bright the pixel appears. The transmittance of the liquid crystal is controlled by voltage on electrodes in the pixel. A pattern of pixels having varying levels of brightness is formed on the display to produce an image by controlling the voltage on the electrodes in each pixel of the display. Images provided by this type of display generally suffer from low brightness and low contrast.

A flat panel display, hereinafter referred to as a “micro-mechanical display”, of a second type, has pixels each of which comprises at least one movable structure micro-machined on a silicon substrate. The position of the at least one moveable structure in each pixel controls how bright the pixel appears by controlling an amount of light that the pixel reflects or diffracts. Generally, the position of the at least one moveable element is controlled by electrostatic forces between the at least one moveable element and electrodes in the pixel that are generated by applying appropriate voltages to the electrodes. Often the voltages are relatively high and moving the at least one moveable element requires a relatively large expenditure of energy. Usually, in these types of displays, brightness and image contrast are dependent upon viewing angle, as measured with respect to the normal to the plane of the display, and decrease as the viewing angle increases. Some of these displays require an internal light source that consumes relatively large amounts of power when operating.

A micro-mechanical display in which the at least one moveable structure in pixels in the display comprises a plurality of parallel flexible reflecting ribbons is described in U.S. Pat. No. 5,841,579 to D. M. Bloom et al, which is incorporated herein by reference. The flexible ribbons in a pixel of the display are normally located parallel to the plane of the substrate on which the pixel is formed at a small distance above the plane. The ribbons are controllable to be depressed towards the substrate by electrostatic forces that are generated by voltages applied to electrodes in the pixel.

To form an image on the display, the pixels in the display are illuminated with light from a suitable light source so that light is incident on the pixels at a given angle with respect to the plane of the display. When alternate ribbons of the plurality of ribbons in a pixel are depressed, the plurality of ribbons in the pixel form a diffraction grating that diffracts some of the incident light at an angle such that the pixel appears blight to a user of the display. If alternate ribbons are not depressed, the plurality of ribbons in the pixel reflect the incident light at a different angle such that light from the pixel does not reach the eye of the user and the pixel appears dark. An appropriate pattern of bright and dark pixels forms the image on the display. The patent describes methods for using pixels of the type described to produce a flat-panel displays that provide color images.

Another type of micro-mechanical display is described in U.S. Pat. No. 5,636,052 to S. C. Arney et al, which is incorporated herein by reference. In this flat-panel display the at least one moveable element in a pixel is a membrane. The membrane is flexibly supported so that it is parallel to the substrate with a small air gap between the two. Light that is incident on the pixel is reflected by both the substrate and the membrane. The height of the air gap determines whether the reflected light from the membrane and the substrate interfere constructively or destructively and therefore if the pixel appears bright or dark respectively. An addressable electrode in the pixel, when charged attracts the membrane towards the substrate thereby controlling the height of the air gap and therefore whether the pixel is bright or dark. In order to displace the membrane, relatively high voltages, on the order of tens of volts, must be applied to the addressable electrode.

It should be noted that, generally, MEMS produced displays are very small in overall size and auxiliary optics (such as projection optics or magnifying optics) are generally used in viewing the display.

The publications listed above in the Related Applications section describe a flat panel display produced by MEMS technology in which a panel is flipped from a first position in which one side of the panel is visible to a second position at which a second side of the panel is visible by application of an electric field. The present invention describes a system having a construction generally analogous to that described in these publication, with improved performance.

### SUMMARY OF THE INVENTION

An aspect of some embodiments of the present invention is concerned with electromechanical displays having very small display elements.

In an embodiment of the invention, the display comprises pixels, each of which includes a panel that is mechanically flipped so that opposite faces of the panel, having different colors or shades can be selectively viewed. In an embodiment of the invention, the panel rotates about an axis on which a rounded (but not necessarily round) axle is formed. In an exemplary embodiment of the invention, the axle is a horizontal axis. Optionally, the panel flips from one position at which it is substantially parallel to (or at an acute angle to) a viewing face of the display to another position in which it is substantially parallel to (or at an acute angle to) the viewing face. In the two positions, opposite faces are viewable. As used herein, the term “rounded” means a cylinder or edge which has a generally rounded shape. The term includes a generally circular shape. It also includes a generally elliptical shape and all or a portion of a hexagon, pentagon or octagon or shape having a greater number of sides. It also includes a shape that is in the form of stepped layers having a generally round outline.

An aspect of some embodiments of the present invention is concerned with a method of rotating an object about an axis substantially parallel to the surface of a substrate on which the object is formed. In an embodiment of the invention, the object is formed with an axle along an axis about which it turns. The axle may be rounded, but may also be square. The axis is substantially horizontal to the surface. Optionally, the axle rolls along at least one rolling surface that is substantially parallel to the substrate surface. In an exemplary embodiment of the invention, the object, the axes and the rolling surface are produced by MEMS technology.

An aspect of some embodiments of the invention is related to methods for producing rounded objects having an axis parallel to the surface of a substrate, using MEMS technology. Such objects can, for example, roll in a direction parallel to the surface. It is also contemplated that such rolling can be perpendicular to the surface or at an angle to the surface.

In an embodiment of the invention, a cylinder having a substantially square cross-section is produced and material is selectively removed from the corners of the square cross-section to form a rounded axle. In an embodiment of the invention, successive steps of partial mask removal and etching of the cylinder are used. Optionally, the mask comprises a first material outer layer that overlays a second material inner layer, except at the corners (and optionally at one side of the cylinder facing the substrate). Portions of the inner layer near the corners are successively removed, for example by selective etching. An etch for the cylinder material is applied which removes cylinder material from the corner and from a short distance under the inner layer. The process of removing part of the inner layer mask by selective etching is repeated one or more times until a desired, rounded, shaped cylinder is achieved. One shape that can be achieved is a generally circular shape having “notches” or steps that represent the layered nature of the process by which the shape is formed. The first material may be polysilicon. Alternatively, the first material may be a metal or a plastic material.

In an embodiment of the invention, the rounded cylinder acts as an axle for rotation of an object to which it is attached. Optionally, a surface having a thin long surface, along which the axle rolls, is also generated.

An aspect of some embodiments of the invention is concerned with a method of flipping a panel in a micro-mechanical display. In an embodiment of the invention, a panel, optionally having different colorings or surface finishes, is constrained to have two stable positions in which different faces of the panel are visible. The panel is formed with an axle around which it generally rotates (although some sideways movement may also be present). The axle is spaced from the edge of the panel, leaving an electrically conducting “tail” on the other side of the axis from a main portion of the panel. In order to flip the panel a voltage is applied to an electrode under the tail which attracts the tail and by leverage, starts the flipping action, by rotating the panel about the axle. As the panel reaches a vertical position (i.e., it is perpendicular to the surface on which it is mounted), the voltage is shut off and the panel continues to rotate by inertia, and is completely flipped over.

Optionally, levitation electrodes are provided above the surface, outboard of the edges of the panel at the stable positions. The levitation electrodes have the function of one or both of (1) raising the panel from a base on which it rests to negate stiction prior to the flipping and (2) inhibiting the flipping action. These functions are achieved by providing a voltage at the levitation electrodes which attracts the panel and lifts it, at the same time inhibiting the rotation of the panel by the flipping electrode. When the levitation electrode is reduced, the substrate electrode flips the panel. Optionally, the levitation electrode at the other stable position is turned on (or is always on, to aid the rotation and/or to provide a soft landing for the panel). A further optional function of the leviation electrodes is to hold the panel in the stable position so that it does not flip by itself.

There is thus provided, in accordance with an exemplary embodiment of the invention, apparatus comprising:

a substrate, having a substrate surface;

an object having a maximum dimension smaller than 1 mm;

an axle, having an axis, attached to the object body; and

an axle support attached to the substrate and having a support surface, wherein:

the axle has a rounded cross-section, as manufactured;

the axle forms a non-zero angle with a perpendicular to the surface; and

the object is capable of rotating about the axle.

In an embodiment of the invention wherein the axle rolls along the axle support surface as the object rotates.

In an embodiment of the invention the apparatus includes at least one socket within which the axle rotates. Optionally, the socket overlays the axle support surface and the axle is held between the support surface, edge constraints and a top constraint. Optionally, the distance between the side constraints is, larger than a diameter of the axle, and the axle is not constrained by the socket between the side support surfaces.

In an embodiment of the invention, the axle is comprised in two axially separated parts and the object is attached to the axle between the two parts. Optionally, the object extends on both sides of the axle in a direction perpendicular to the axis of the axle.

Optionally, the maximum extent of the object is less than 200 micrometers. In some embodiments it is less than 90, 50, 20 or 10 micrometers.

In an embodiment of the invention, the axle support surface is generally parallel to the substrate surface. In an embodiment of the invention, the axis of the axle is substantially parallel to the substrate surface.

In an embodiment of the invention, the object is a planar object whose planar surface is parallel to the axle. Optionally, the planar object is adapted to be rotated from a first position at which one side of the object is visible to a second position at which a second side of the planar object is visible.

There is further provided a micro-mechanical display apparatus comprising a planar object according to the invention. In an embodiment of the invention, the planar object extends to a first extent on one side of the axis and extends to a lesser extent on a second side.

In an embodiment of the invention, the display includes an electrityable surface area on or in the substrate under at least a portion of the lesser extent; Optionally, the planar object is electrically conducting over at least a portion of its extent. Optionally, the planar object is conducting over at least a portion of the lesser extent.

There is further provided, in accordance with an exemplary embodiment of the invention, micro-mechanical display apparatus, comprising:

a substrate;

a plurality of pixels on the substrate, each comprising:

a planar object; and

an axle, about which the planar object is rotatable, the planar object being adapted to be rotated from a first position at which one side of the object is visible to a second position at which a second side of the planar object is visible;

wherein:

the planar object extends past an axis of the axle, to a greater extent on one side and to a lesser extent on a second side thereof;

the planar object is conducting at least over a portion of the lesser extent, further comprising:

an electrityable surface area on or in the substrate under at least a portion of the lesser extent.

Optionally, the pixel includes at least one socket that at least partially constrains movement of the axle.

In an embodiment of the invention, the pixel includes a source of electrical voltage that provides a non-zero voltage to said electrifable surface area, to attract the lesser extent thereto, initiating rotation of the surface area.

In an embodiment of the invention, the pixel includes at least one levitation electrode situated past the greater extent and above a resting position of the planar object, the at least one levitation electrode being electrifyable.

In an embodiment of the invention the display includes a controller that controls selective electrification of the electrifyable surface area and the levitation electrode to cause the planar element to flip from the first position to the second position;

Optionally, at least a portion of the planar object near the axis on the portion of greater extent is either missing or non-conducting.

Optionally, the first face of the planar object is finished in a first manner and the second face of the panel is finished in a second manner. Optionally, when the planar object is in the first position or the second position, a visible area on the far side of the axis is finished in a manner similar to the visible face of the planar object. Optionally, the different finishes comprise different colors.

In an embodiment of the invention, the object is comprised of polysilcon, optionally, coated at least partially with another material. Optionally, the axle is comprised of polysilicon.

Alternatively or additionally, the object is comprised of a metal, optionally, coated at least partially with another material. Optionally, the axle is comprised of a metal.

In an embodiment of the invention, the substrate is silicon. Alternatively, the substrate is glass. In an embodiment of the invention, the substrate is flexible.

There is further provided, in accordance with an embodiment of the invention, a method of forming a rounded cylindrical element, comprising:

(a) providing a rectangular cylindrical element of a first material that can be etched with a first etchant;

(b) coating at least some of the surfaces of the rectangular cylindrical element with a layer of a second material etchable with a second etchant and resistant to the first etchant;

(c) overcoating the second material with a third material, resistant to the first and second etchants, the third material being discontinuous at at least some corners of the cylindrical element;

(d) etching the second material with the second etchant, at the corners to remove a portion of the layer of second material adjacent the corners;

(e) etching the first material with the first etchant to remove a portion of the first material at the corner and under a portion of the remaining second material layer.

Optionally, the method includes repeating (d) and (e) at least once or a plurality of times.

Optionally, the method includes removing any remaining first and second materials.

In an embodiment of the invention, the first material is polysilicon. Optionally, the second material is an oxide or glass layer. Optionally, the third material is silicon nitride.

Alternatively, the first material is a metal.

There is further provided, in accordance with an embodiment of the invention, a method of flipping an object having an axle about which the object is generally rotatable, from a first position at which one area of the object is visible to a second position at which a second area of the object is visible, the object extending radially past an axis of the axle, to a greater extent on one side and to a lesser extent on a second side thereof, the method comprising:

constraining the panel from flipping;

providing an electric field to at least a portion of the lesser extent, in a direction that tends to move the panel from the first toward the second positions

In an embodiment of the invention, the method includes removing the constraint against flipping, such that the object flips from the first position to the second position.

Optionally, constraining comprises electrifying an additional electrode and where removing the constraint comprises removing the electrification.

Optionally, the object is conducting at least over a portion of the lesser extent.

In an embodiment of the invention, the object is a generally planar object and wherein one face of the planar object is visible in the first position and a second face of the object is visible in a second position. Optionally, the object is a generally rectangular panel.

In an embodiment of the invention, the additional electrode is an electrode situated in a plane different from that of the planar object in the first position or the second position. Optionally, the additional electrode is situated below the plane of the first position. Alternatively, the additional electrode is situated above the plane of the first position and to the side of the planar object when it is in the first position.

Optionally, the object is comprised of polysilicon. Alternatively, the object is comprised of a metal.

In an embodiment of the invention, the object has a maximum dimension of less than 1 mm.

### BRIEF DESCRIPTION OF FIGURES

Exemplary, non-limiting embodiments of the invention are described in the following description, read in with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are generally not to scale. The attached figures are:

FIG. 1A is a schematic overview of a pixel in a display, in accordance with an embodiment of the invention;

FIG. 1B shows details of a axle about which a panel in the display rotates, together with a cut away version of a socket in which the axle rotates, in accordance with an embodiment of the invention;

FIG. 1C shows a cross-section of the axle and socket, in accordance with an embodiment of the invention;

FIG. 1D shows a simplified cross-section of a substrate electrode and a tail of a panel, in accordance with an embodiment of the invention;

FIGS. 2A-2D illustrate the methodology of flipping, in accordance with an embodiment of the invention;

FIGS. 3A and 3B illustrate the effect of downward and side constraints on flipping;

FIGS. 4 and 5 are two possible timing diagrams of voltages for flipping, in accordance with embodiments of the invention;

FIGS. 6A and 6B illustrate the results of initial process acts in the formation of the pixel, in accordance with an embodiment of the invention;

FIGS. 7A-7C illustrate formation a second polysilicon layer, in accordance with an embodiment of the invention;

FIGS. 8A-8D illustrate the formation of a round axle, in accordance with an embodiment of the invention;

FIG. 9 illustrates portions of the pixel, after rounding of the axle, in accordance with an embodiment of the invention; and

FIGS. 10A and 10B show the final stages of fabrication of the pixel, in accordance with an embodiment of the invention.

### DESCRIPTION OF EXEMPLARY EMBODIMENTS

### Overview of the Pixel Construction

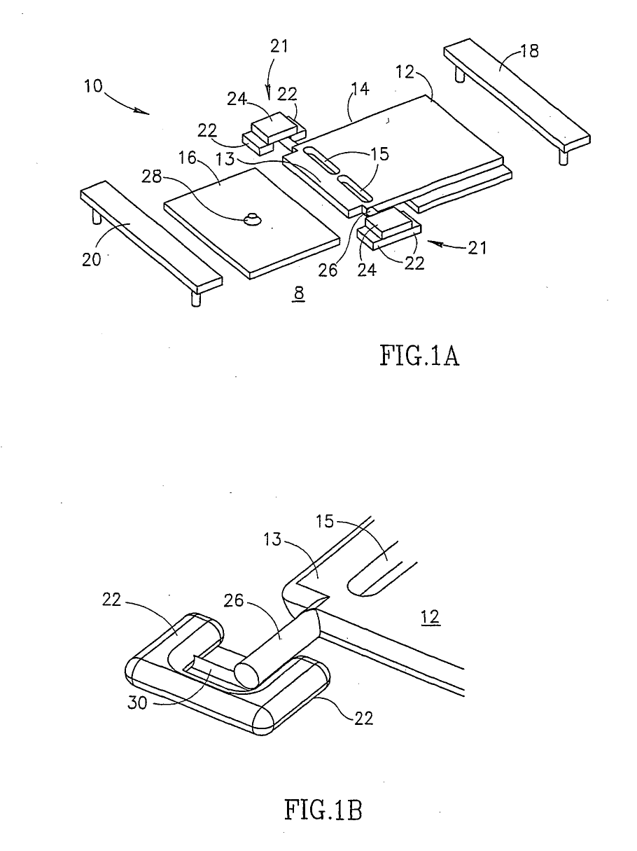

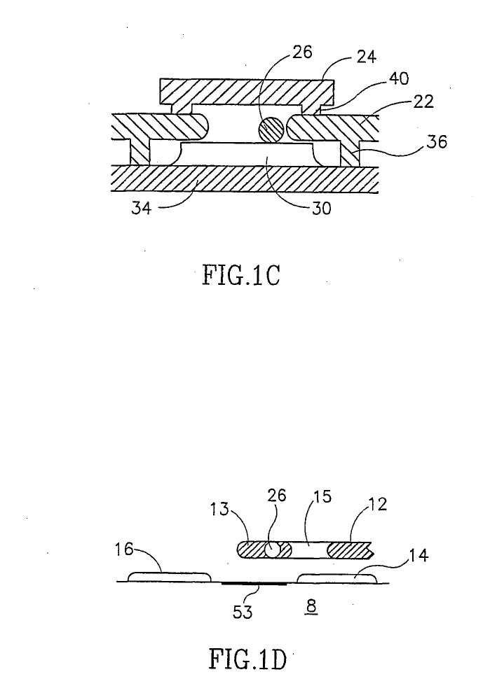

FIGS. 1A-1C show an overview of an exemplary pixel 10, in accordance with an embodiment of the invention. While this construction is presented as an example, many of the elements shown can have a different construction and some may be deleted altogether.

Pixel 10 comprises as its major components a flipping panel 12, electrodes 14 and 16, levitation electrodes 18 and 20 and a pair of sockets 21. The panels are formed with preferably rounded axles 26, which fit into sockets 21. The sockets comprise a lower, optionally wedge shaped, element 30 (sometimes referred to herein as a “knife 30”) formed with an upper edge on which the related axle rolls, a pair of side motion constraints 22 and an upper constraint 24. Each electrode is optionally formed with an optionally insulated nub 28 which minimizes the area of contact between the panel and the underlying structure and in particular, the underlying electrode.

FIG. 1A shows an isometric view of the pixel in one position, FIG. 1B shows a view of a socket 21 with upper constraint 24 removed and FIG. 1C shows a cross sectional view of socket 21, at a different cut, including the poly 0 layer 34 on which the knife sits and vias 36 and 40 that connect the parts together mechanically and electrically.

In the method of construction described below, the entire structure is made essentially of polysilicon, which is deposited in three layers, designated Poly 0, Poly 1 and Poly 2, which are formed on a silicon substrate 8. In other embodiments, the structures can be metal or even plastic (metalized or made conducting by other means). For ease of visualization, the layers are indicated with a same type of diagonal cross-hatching with layers 0 and 2 having right leaning diagonal lines and layer 1 having left leaning diagonal lines. In general, all of the polysilicon is made conducting. In an embodiment of the invention, electrodes 14 and 16 (including nub 28) and 30 are laid down in Poly 0, panel 12 (including axle 26) and side motion constraints 22 are laid down in Poly 1 and levitation electrodes 18 and 20 and upper constraint 24 are laid down in Poly 2.

The upper surface of electrode 16 and the visible face of panel 12 are coated with a first coating which visually gives them a first color. The first and second colors can be black and white, for example. The upper surface of electrode 14 and the other face of panel 12 are coated with a second coating that gives them a second color. Thus, when the panel is in the position shown, both the panel and the visible electrode (16) have the same (first) color). When panel 12 is flipped, so that it covers electrode 16, the visible electrode (14) and the panel have the second color.

In exemplary embodiments, the panel is 85×85 micrometers and the axle has a diameter of 2 micrometers. Alternative designs in which the panels have a 40×85 micrometer (resulting in a square pixel of 85×85) or a larger size (0.2×0.2 nm is contemplated, but 1 mm×1 mm is possible) and as small as 10×10 micrometers or smaller are also within the scope of the invention. For the smaller sizes, the size of the axle may be reduced. For very large panels, it may be increased.

### Flipping of the Panels

In an embodiment of the invention, electrodes 14 and 16 and knife 30 are energized together. Axle 26 contacts the upper edge of knife 30, so that panel 12 is energized at the same time. Thus, electrodes 14 and 16 and panel 12 are at the same potential. Left (20) and right (18) levitation electrodes are separately electrified and an electrode 53 in substrate 8, on which the entire structure sits, is also separately electrified. For ease of understanding of the flipping operation, FIG. 1D illustrates a cross-section of the pixel structure between the hinges. In this cross-section only electrode 53, electrodes 14 and 16 and panel 12 are present. As illustrated, panel 12 is formed with a tail end 13 that extends beyond axle 26 (shown in FIG. 1D in white, to illustrate its position). A long slot or series of slots 15 are formed in panel 12, on the other side of the axle from the tail. The function of tail 13 and slots 15 will become evident in the following discussion.

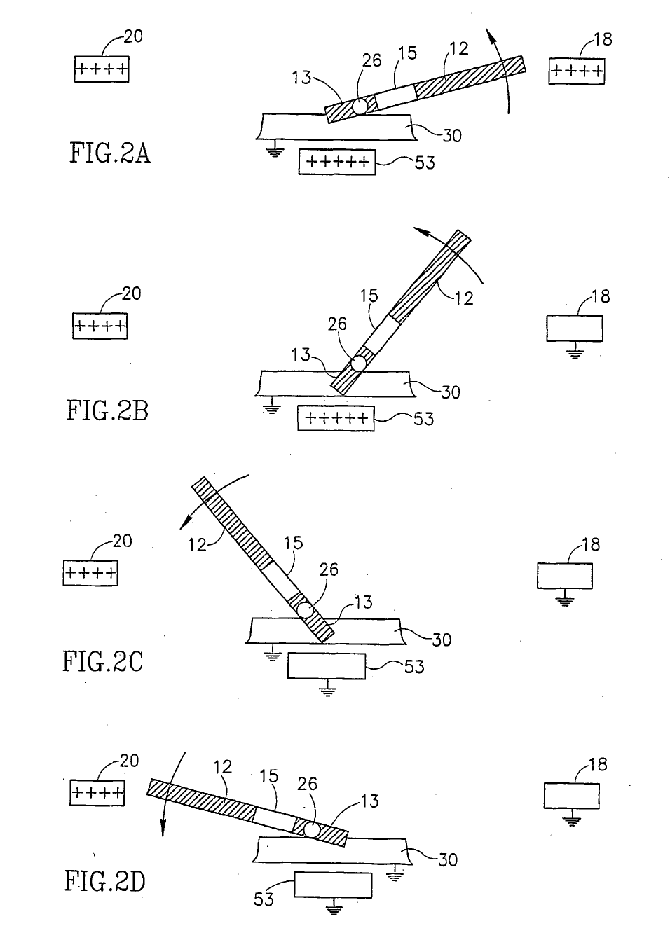

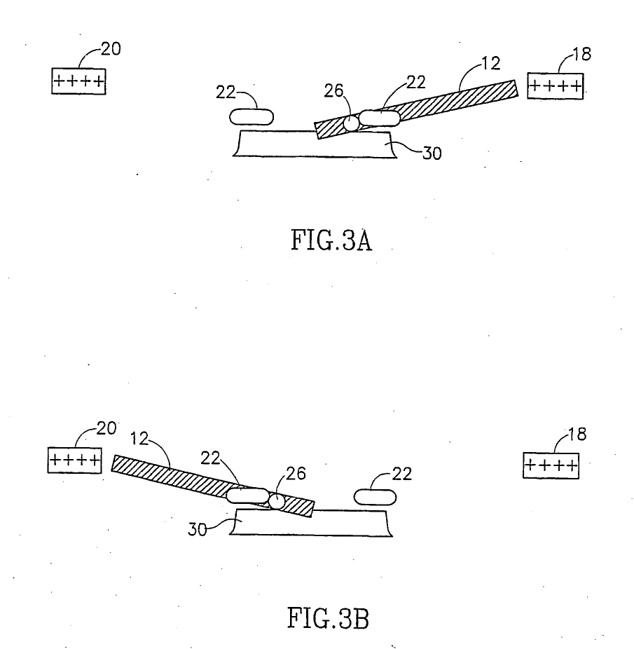

FIGS. 2A-2D illustrate a method of flipping the panel. As a first act (FIG. 2A), both levitation electrodes are electrified. Since the levitation electrodes are Poly 2, panel 12 is Poly 1 an the electrodes (and nubs) are Poly 0, the electrification of the levitation electrode will tend to lift the panel off the nubs (reducing stiction). The panel and the electrodes are both at the same potential (grounded in this case), so that there is no electrical attraction between the panel and the electrodes. On the other hand, electrode 53 is also electrified, so that tail 13 is attracted to the substrate. Since slots 15 are cut in the panel, the portion of the panel to the right of axle 26 is not substantially attracted to the substrate. A further effect of the attraction of panel 12 to electrode 18 is the positioning of axle 26 at the right of the slot formed by knife 30 and constraining elements 22 and 24. This is illustrated in FIG. 3A. Knife 30 is thin to reduce stiction which can inhibit motion and rolling, or at least its initiation.

In FIG. 2B, the voltage on electrode 18 has been turned off and the effect of the attraction between tail 13 and electrode 53 is to pull down tail 13 and provide leverage to lift the rest of panel 12, as shown. Momentum generated during this lifting operation and attraction of the panel to levitation electrode 20, which remains electrified, carries the panel past the upright (FIG. 2C) and toward levitation electrode 20 and electrode 16. Optionally, at this time (when the panel passes the upright), the voltage on the substrate electrode is removed to enable the panel to continue to move towards electrode 16. Alternatively, the voltage on the substrate electrode is maintained, possibly at a reduced voltage, inter alia to insure that axle 26 remains in contact with knife 30. However, this contact is not essential to the operation. In FIG. 2D, the fall of the electrode has been arrested by its attraction to levitation electrode 20. The voltage on levitation electrode 18 can then be released or it can be maintained to keep panel 12 from being dislodged from its new position. Alternatively, the panel can be allowed to fall to contact nub 28. It has been found that, for practical purposes, the stiction between panel 12 and nub 28 is often sufficient to hold the panel in place. As a further effect, the attraction of the panel to levitation electrode 20 serves to position the panel in a position ready for the next flipping (FIG. 3B).

It should be indicated that while the voltage is indicated as being positive, the flipping works in exactly the same manner whether the voltages are positive or negative.

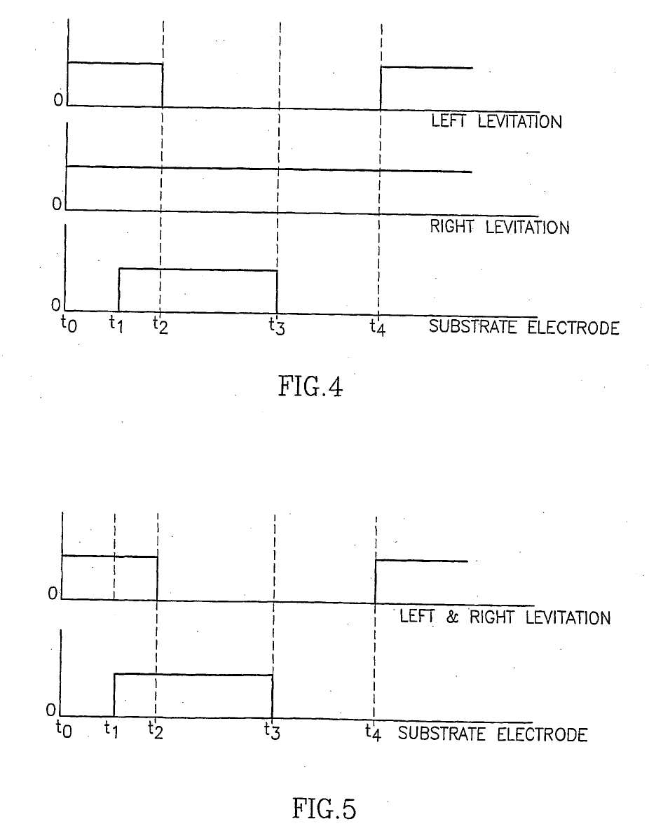

FIGS. 4 and 5 illustrate possible timing diagrams for flipping a panel. It is noted that the voltage schemes shown in FIG. 4 will flip the panel from left side to the right side. Further note that the panel, right electrode and left electrode are grounded for both timing diagrams.

In FIG. 4, at to, the system is at rest and both levitation electrodes are electrified. The substrate is turned off. At t₁ the substrate is turned on. (FIG. 2A) Then at t₂, the left levitation electrode is grounded, starting the flipping (FIG. 2B). At t₃, the left levitation electrode is then turned off and the substrate is preferably turned off (for example, grounded). (FIG. 2C.). If the substrate is turned off, this reduces any retardation of the flipping. Alternatively, the substrate is left on until just before the next flipping operation. At t₄, the electrode is in place, held in place by the right levitation electrode (FIG. 2D). The left levitation electrode and substrate electrode may then optionally be turned on, since they will not cause flipping so long as the right electrode is on.

FIG. 5 shows a timing diagram for an alternative method which will flip any panel from one side to the other, irrespective of its starting position. It is very-similar to the timing diagram of FIG. 4, except that both levitation electrodes are tuned off and on at the same time. Thus, the panel will be released by whichever levitation electrode it is being held and start flipping to the other side. The substrate is turned off and the completion of the flipping is by inertia. Both levitation electrodes are turned on some time after the panel passes the upright position. Attraction to the levitation electrode on the “new” side, completes the flipping. The levitation electrode on the “old” side, is far enough away so that it does not retard the panel.

It should be noted that if the substrate electrodes 53 are provided (see alternatives below), electrodes 14 and 16 can be omitted, with the substrate being held at ground. A nub is still preferably formed.

Alternatively or additionally, only the tail portion and the portion at the opposite edge of the panel is made conductive (with a conductive strip connecting them both to the axles). This obviates the need for cut-outs 15.

In practice, the pixels are arranged in rows and columns with the substrate electrode being comprised, for example in a highly conductive doped layer at the surface of the substrate running along a stip at the center of the pixels (the substrate electrode) and forming a column electrode. The right levitation electrodes in a row are connected to a first row address line and the left levitation electrodes are connected to a second row address line. If the addressing scheme shown in FIG. 5 is used, then only one row address line is used.

To address any pixel, the substrate electrode for the column containing the pixel is activated as shown in FIGS. 4 and 5 and the proper (or both) levitation electrode for the row containing the pixel are activated (grounded) according to the timing diagram of the figures. Other pixels in an activated column are not effected, since the levitation electrodes are both on, retarding flipping. Other pixels in a row for which the levitation electrode voltage or voltages drop are also not effected, since the substrate electrode voltage does not rise to cause flipping. Only pixels for which both the substrate is pulsed “on” and the adjacent levitation electrode is pulsed “off” will flip.

In other embodiments of the invention, the construction is somewhat different and the flipping and/or addressing methods are varied to suit. For example, in an alternative embodiment electrode 53 is omitted and the entire substrate is pulsed on for each cycle. Electrodes 14 and 16 are also electrified for each column except for those-columns that contain the pixel (or pixels) to be switched. This electrification of electrodes 14 and 16 attracts the grounded panel and inhibits switching even when the substrate is electrified and the levitation electrodes are turned off.

Additionally, even for this embodiment, only a portion of the panel need be conducting, since attraction of only a portion of its area to the electrode is needed to overcome the effects of the substrate voltage on the much smaller tail.

Alternatively, for pixels in a row being addressed, electrodes 14 and 16 are electrified together with or instead of the levitation electrodes. Electrodes 14 and 16 thus perform the control (or inhibiting) function of the levitation electrodes. However, use of levitation electrodes, at least at the start of the flipping, is preferred, since they provide extra force to help break the stiction force between the panel and the nubs.

Variations in construction and flipping methodology will be apparent to persons of skill in the art. Some methods of flipping utilize the principle described above (flipping by attracting the tail to the substrate and utilizing the levitation electrode to control the flipping). Other methods however, such as those described in the publications in the related applications section, can be used for flipping.

It should also be noted that while a rounded axle is preferred, square axles can also be flipped using the above methodology, albeit at a higher applied voltage, generally lower switching speed and potentially reduced reliability.

Charge accumulation near the interface between layers of polysilicon and silicon nitride and between silicon nitride and air may occur if high voltages are left on for extended periods. This accumulation may disturb the flipping signals. Such accumulation is optionally avoided by using the lowest possible voltages, alternating the polarity of the voltages in alternate flipping cycles, using timing cycles with minimum voltage on times (for example, shutting down all voltages between flipping cycles and relying on stiction to keep the panels in place) and avoiding placing such interfaces in regions of high field.

In an embodiment of the invention, a display is produced on a substate, such as a glass substrate already having a network of driving thin film transistors (TFT), deposited thereon. This results in an active matrix display and allows for lower addressing voltages and less cross-talk. Flexible substrates can also be used. Use of non-silicon substrates enables construction of larger displays, with 15 inch or larger displays being contemplated. Using a silicon substrate displays of 2×3.5 cm, suitable for a telephone or 6×6 cm, for use in a palm computer, or larger can be conveniently produced. For an 85×85 micrometer panel, produced as described below, but without the substrate electrode (and using electrification of electrodes 14 and 16 as flipping inhibitors, as described above) voltages as low as 16 volts provide reliable flipping. Using smaller pixels or further reducing stiction may reduce the operating voltage to as low as 10 or even 5 volts. The flipping time is less than 0.2 milliseconds, resulting in a flip rate of at least 5000 flips/second or 200 flips/frame at 25 Hz. This allows for a very large gray scale variation in the display, by changing the percentage of time that the panel is on the dark and light sides.

### Fabrication of the Pixels

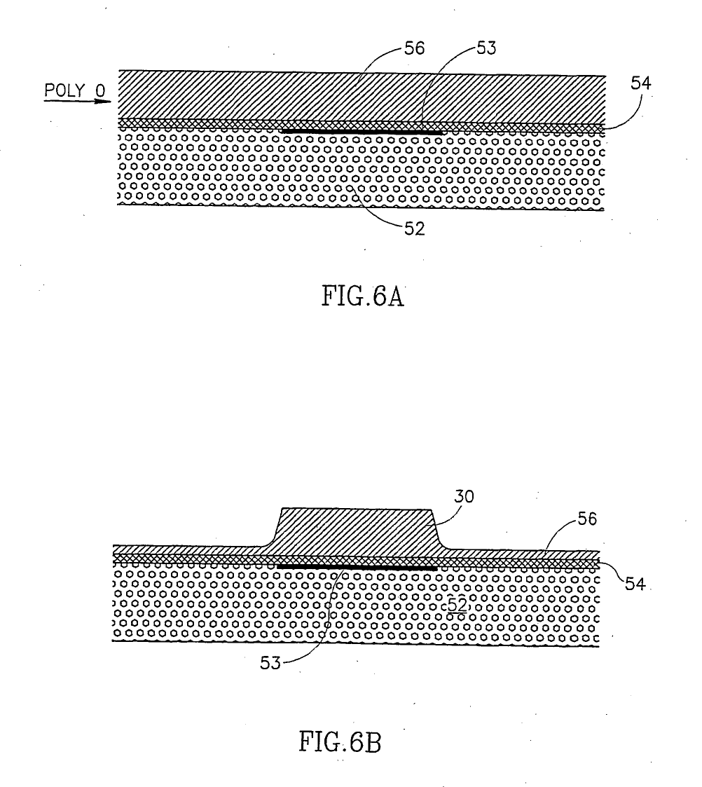

FIGS. 6-10 illustrate an exemplary methodology for the fabrication of a pixel as shown in FIG. 1, in accordance with an embodiment of the invention. Of course, an entire array of such pixels is produced by the method on a single substrate.

The following are the acts in the process, which are listed and referenced in the following list and described in the explanation of FIGS. 6-10. In general, each deposition of an oxide or glass layer is followed by an anneal. It is noted that the method described is based on the process technology utilized by a particular foundry and that details may vary, even for the same process methodology. It should also be noted that for some of the oxide etches, an overlying nitride layer is used as a mask and for at least some of the polysilicon etches, the nitride and/or oxide layers are used as a mask.

A-Start wafer;

B-Form substrate electrodes;

C-Silicon nitride deposit

D-Poly 0 (polysilicon) deposit;

E-POCl₃ doping;

F-Nub and knife support etch (Plasma etch);

G-Poly etch to form electrode edges, levitation electrode address lines;

H-Silicon Nitrate deposit (0.04 micrometers);

I-Nitride etch;

J-Silicon Nitride deposit (0.18 micrometers);

K-Nitride etch to expose knife;

L-Sacrificial Oxide Deposit 0; and Chemical Mechanical Polishing;

M-Phosphor-silicon glass deposit;

N-Silicon Nitride deposit (0.22 micrometers);

O-Nitride etch;

P-Anchor 1 etch (oxide etch) for sockets and levitation electrodes;

Q-Poly 1 (polysilicon) deposit;

R-Phosphor silicon glass deposit and anneal;

S-Buffered oxide etch;

T-Silicon Nitride deposit (0.18 micrometers);

U-Nitride etch;

V-Low temperature oxide deposit;

X-Silicon nitride deposit;

Y-Poly 1 etch to form panel, side motion constraints;

Z-Buffered oxide etch 500 Å;

AA-Low temperature oxide deposit;

CC-Silicon Nitride deposit;

DD-Reactive ion etch of horizontal nitride;

EE-Buffered Oxide Etch 3200 Å;

FF-Wet poly etch 800 Å;

GG-Buffered oxide etch 500 Å;

HH-Wet poly etch 800 Å;

II-Buffered oxide etch 1000 Å;

JJ-Poly Oxidation;

KK-Buffered oxide etch 10 seconds;

LL-Wet Nitride etch 600 Å+50-100% over-etch;

MM-Sacrificial oxide 1 deposit; NN-Anneal (x2); and OO-Chemical Mechanical polishing;

PP-Silicon Nitride deposit 600 Å;

QQ-Anchor 2 Etch (oxide etch) for sockets and levitation electrodes;

RR-Poly 2 (polysilicon) deposit;

SS-Phosphor silicon glass deposit;

UU-Poly 2 Etch to form upper axle constraint and levitation electrode;

VV-Reactive ion etch of horizontal nitride;

WW-Wet Nitride Etch 50 min;

XX-Reactive ion etch of horizontal nitride (hard mask removal);

YY-Removal of sacrificial oxide.

These acts are now related to FIGS. 6-10.

FIG. 6A shows the substrate after process A-E. The substrate is indicated as 52, an insulating silicone nitride deposit (C) is indicated as 54. It is typically 0.6 micrometers thick. The Poly 0 deposit (D), typically 2 micrometers, is indicated by reference 56. The substrate electrode (B) (column) line is indicated as 53. The exact shape of the electrode itself is not shown but it is formed between the sockets (FIG. 1) and has a width that is typically greater of the space between the side constraints or the width of the tail plus the diameter of the axle, limited by the fact that the tail must clear the substrate when the panel flips. After deposition of the poly 0 layer it is made conductive by process E.

FIG. 6B shows the substrate after process F. Process F consists of forming a mask over the nubs and knife and then plasma etching the oxide to a depth of 1.5 micrometers. The plasma etch eats below the mask, providing a low top area for the nub and a fairly thin and long knife edge 30. Note that a portion of Poly 0 remains over the entire surface and is at a higher level at the knife and nubs. In general, if the oxide is etched 1.5 microns, for a 2 micron mask size, the knife and nub are etched under the mask so that about 1 micron width remains at the surface. This reduction in width reduces stiction and resistance to separation of the panel from the nubs and the initiation of rolling of the axle.

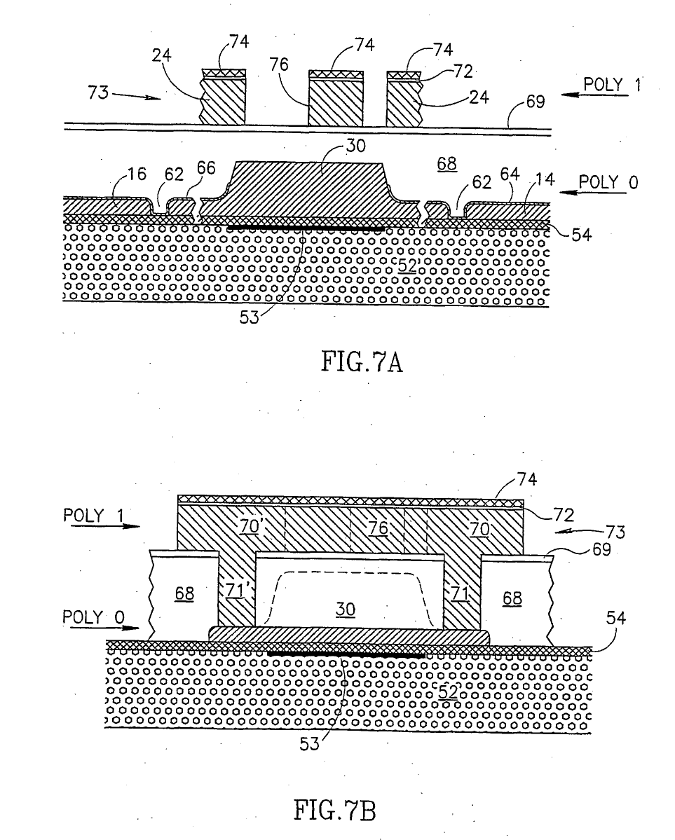

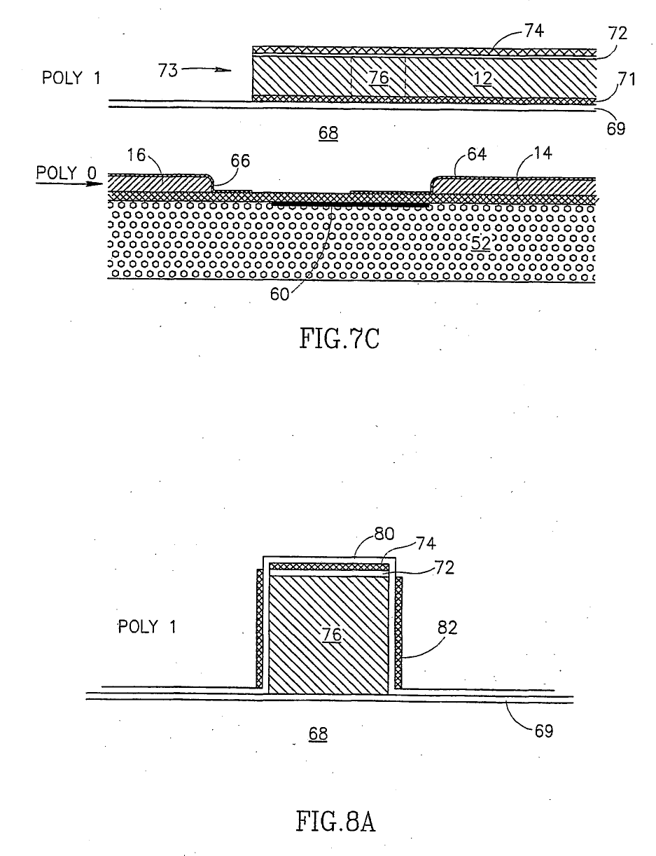

FIGS. 7A-7C show three cross-sections of the substrate after process act Z. FIG. 7A shows a cut through the center of knife 30 (same as FIG. 6B). FIG. 7B shows a cut through elements 22, 24 somewhat further from the panel than that shown in FIG. 1C. FIG. 7C shows a cut halfway between the sockets to show both the formation of the tail of the panel and the extent of the substrate electrode, indicated here as element 60. The configuration shown in FIGS. 7A-7C is achieved by polyetching (G) to form levitation electrode address lines and the electrode 14 and 16 edges (G). A base for the socket is also defined in this process. A non-conducting space 62 is formed between the knife support and the electrodes. A silicon nitride deposit of 0.04 micrometers is deposited (H) and removed (I), everywhere except on top of electrode 14 and the right end of knife 30 (also removed from electrode 16). A further silicon nitride layer of 0.18 micrometers is deposited (J). This results in a silicon nitride layer of 0.22 microns on electrode 14 (reference 64) and 0.18 microns on electrode 16 (reference 66). These two thicknesses of nitride, when viewed, provide dark and light shades respectively. These thicknesses vary depending on the process. Other colors may be achieved by methods of providing colored surfaces to silicon as known in the art. Such colored surface can be used to provide an RGB display. Colors can for example be produces by adding phosphors to the Nitride material and activating the phosphors with side lighting, for example in the UV.

The nitride is then removed, exposing the poly 0 level at the knife edge K). A sacrificial oxide layer 0 (reference 68) is deposited by a low temperature oxide (LTO) process (typically 2 micrometers) and chemical mechanical polishing is performed so that the depth over knife 30 is 0.5 micrometers. (L). Phosphor Silicon glass (typically 1500 Å thick) is deposited (reference 69) (M) on the polished oxide. Silicon glass and LTO Oxide are both etched by similar etchant. However, Silicon glass is etched more quickly. The use of two different materials allows for more control over the process.

This is overlaid by a silicon nitride deposit (N) of 0.22 micrometers to color the underside of the next layer. The silicon nitride layer is removed (O) everywhere except under the position at which the panel is to be formed. This layer forms the color of the panel seen when the panel is over electrode 16 and is the same thickness as that on electrode 14.

An anchor (oxide) etch (P) is performed to form a conducting vias between the poly 0 and poly 1 layers, where required, namely to connect elements 22 to the poly 0 layer. FIG. 7B shows a cut where these layers/elements for the socket: are connected via the vias. Another place where such vias are formed is beneath the area where the levitation electrodes are to be formed, so that they can be connected to the lead in wires which are on the poly 0 level.

Poly I layer 73 is then deposited (Q). Typically, the poly 1 layer is 2 micrometers thick. A Phosphor silicon glass layer, typically 2000 Å thick is then deposited over the Poly 1 layer and annealed to make poly layer 1 conducting (R). A buffered oxide etch is then performed (S) to remove the remnants of the glass layer. A nitride layer 0.18 micrometers thick is then deposited. This layer gives color to the upper side of the panel 12 (T). The nitride is then etched (U) so that it is removed from the entire surface, except for the surface of the prospective panel. A low temperature oxide 72, typically 600 Å thick is deposited (V) and annealed. A silicon nitride layer 74, typically 600 Å thick is then deposited (X) on oxide layer 72. The poly 1 layer is then etched (Y) to form the general outlines of the elements on the poly 1 level. In general, nitride and oxide layers are used as the masks for etching the underlying polysilicon. An optional buffered oxide etch (Z) is then performed, resulting in the structures shown in FIGS. 7A-7C.

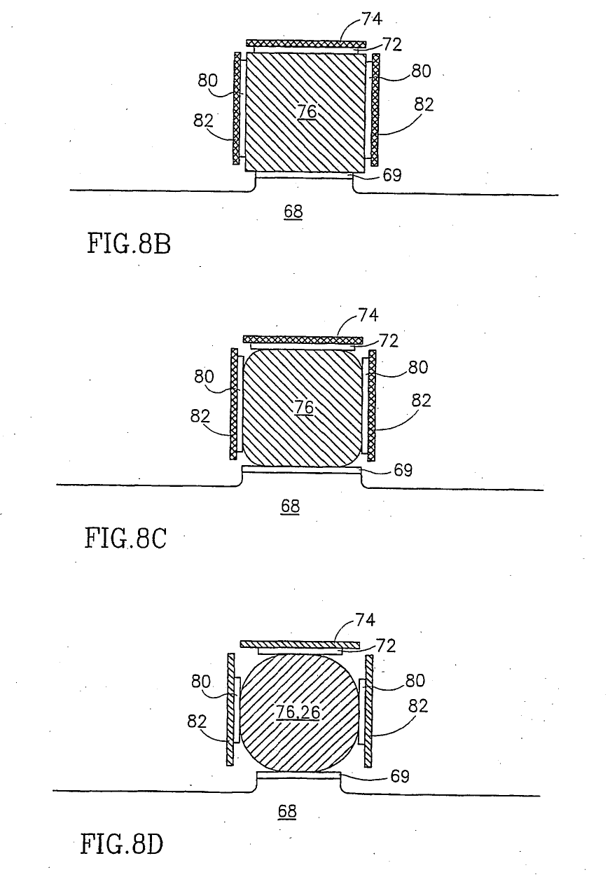

FIGS. 8A-8D illustrate a process for forming rounded horizontal surfaces. In the present case, it also turns element 76, which is the form of a cylinder with a generally square cross section into a cylindrical structure having a more cylindrical cross-section. As a by-product, the ends of elements 24 are also rounded. For clarity only the operation on element 76 is shown. Furthermore, while the rounding results also on all edges in Poly 1, this is not shown on most of the figures for most of the edges, to simplify the presentation.

First a low temperature oxide layer 80, typically 1000 Å thick, is deposited (AA) on the structure and annealed (BB). Then a silicon nitride layer 82, typically 600 Å thick is deposited (CC). Horizontal portions of the silicon nitride are removed by a reactive ion etch (DD). This results in the structure shown in FIG. 8A.

A buffered oxide etch (EE), typically 3200 Å, then removes the oxide overlaying the nitride on top of structure 76. It also undercuts sacrificial oxide 68 and oxide layer 69, as shown in FIG. 8B. A wet poly etch (FF), typically 800 Å, rounds the corners of element 76. as shown in FIG. 8C. FIG. 8D shows the result after an additional 500 Å wet oxide etch (GG) followed by an 800 Å wet poly etch (HH) and a buffered oxide etch of typically 1000 Å, to remove any oxide from the surface of the nitride. This results in the rounding of element 76 so that it becomes ideally a rounded axle 26 (FIG. 8D), although variations, as described above are produced in reality. While the present inventors have found that a two step cylinder forming process as described gives good flipping performance, even though the axle is not perfectly round, a more nearly circular axle or other shape can be generated by increasing the number of oxide etch/poly etch iterations and adjusting the etch depths. Furthermore, for some embodiments of the invention, the axle is not rounded or only a single rounding step is performed.

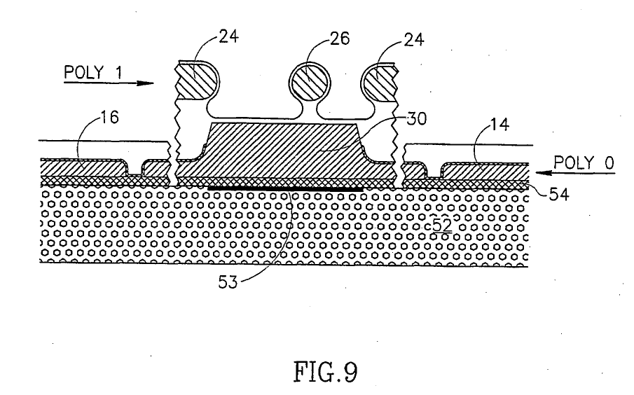

The structure shown in FIG. 9 shows the same cut as FIG. 7A, after applying the process described with respect to FIGS. 8A-8D. A poly oxidation (JJ) followed by a 10 second buffered oxide etch (KK) and a wet nitride etch (LL) results-in a structure shown in FIG. 9.

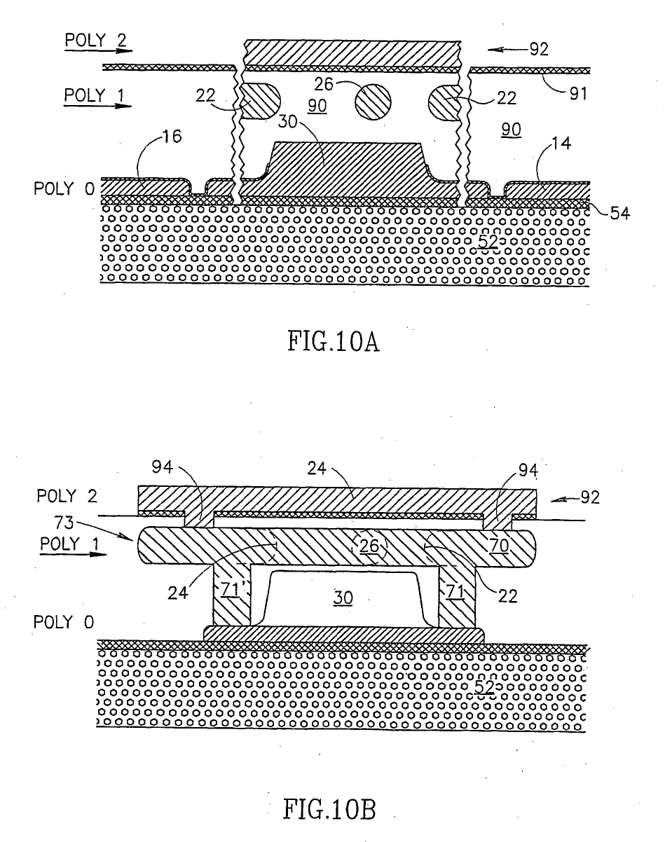

FIGS. 10A and 10B show the results of successive further stages in the fabrication of the pixel, in particular, the deposition and etching of a poly 2 layer. The view of FIG. 10A is the same as that of FIG. 7A and that of FIG. 10B is the same as that of FIG. 7B.

Following the nitride etch, a sacrificial oxide 1 layer 90, of thickness typically 4 microns, is laid down. In an embodiment of the invention, this oxide is laid down in 2 micron steps (MM), with an anneal (NN) between the steps and after the second deposition. This is followed by a chemical mechanical polishing operation (OO) that typically leaves 0.85 micrometers above the poly 1 level. A 600 Å silicon nitride deposit is then formed (PP) above the polished oxide and anchor holes 94 are formed (QQ) for attaching elements 24 (poly 2 level) to elements 22 (poly 1 level) and for attaching the levitation electrodes to their feed-in leads. A typically 1.5 micrometer Poly 2 layer 92 is deposited (RR) to cover the silicon nitride layer 91. This deposit also fills anchor holes 94 and the corresponding holes in the oxide at the levitation electrodes. A phosphor silicon glass (typically 2000 Å) is formed (SS) over the poly 2 layer and annealed (TT). Poly 2 is then etched (UL) to form element 24 and the levitation electrodes. A reactive ion etch and a wet nitride etch (VV, WW and XX) remove any nitride left on the upper layers and a long oxide etch (YY) removes the sacrificial oxide layers, leaving the finished pixel.

It will be clear that the pixel can be made of materials other than polysilicon. In particular, instead of the poly layers, metal layers can be deposited and appropriate etchants used. Furthermore, other materials, other than oxides and silicon nitride can be used in the process of forming the pixel. Finally, appropriate plastic materials can be used in the process, optionally together with metal and/or polysilicon materials.

It will be clear that the present application describes a number of different elements, including, inter alia a rounded (or round) horizontal axle (or other element), a rolling axle, a pixel having a panel that changes position quickly and/or using a low voltage, a method of flipping the panel and a fabrication method. It is understood that while these elements have been described in the context of a display, in order to teach the best mode known to the inventors for carrying out the invention, each of the elements described above is believed to have wider utility in other devices. Furthermore, while the elements have been described in the context where they work together in a single device, it should be clear that many of these novel elements can be utilized, in some embodiments of the invention, without any of (and certainly without all of) the others. For example, the flipping method show will work with a pixel in which the axles have not be rounded or have been only been partially rounded. The rounded axles can be used with flipping methods described in the prior art and in the references listed in the related applications section.

It will also be clear, the present invention has been described using non-limiting detailed descriptions of exemplary embodiments thereof that are provided by way of example and that are not intended to limit the scope of the invention. Variations of embodiments of the invention, including combinations of features from the various embodiments will occur to persons of the art. The scope of the invention is thus limited only by the scope of the claims. Furthermore, to avoid any question regarding the scope of the claims, where the terms “comprise,” “comprising,” “include,” “including” or the like are used in the claims, they mean “including but not necessarily limited to”.

1. Apparatus comprising:
a substrate, having a substrate surface;
an object having a maximum dimension smaller than 1 mm;
an axle, having an axis, attached to the object body; and
an axle support attached to the substrate and having a support surface, wherein:
the axle has a rounded cross-section, as manufactured;
the axle forms a non-zero angle with a perpendicular to the surface; and
the object is capable of rotating about the axle.

2. Apparatus according to claim 1 wherein the axle rolls along the axle support surface as the object rotates.

3. Apparatus according to claim 1 or claim 2 and including at least one socket within which the axle rotates.

4. Apparatus according to claim 3 wherein the socket overlays the axle support surface and wherein the axle is held between the support surface, edge constraints and a top constraint.

5. Apparatus according to claim 4 wherein the distance between the side constraints is larger than a diameter of the axle, and the axle is not constrained by the socket between the side support surfaces.

6. Apparatus according to any of the preceding claims wherein the axle is comprised in two axially separated parts and the object is attached to the axle between the two parts.

7. Apparatus according to claim 6 wherein the object extends on both sides of the axle in a direction perpendicular to the axis of the axle.

8. Apparatus according to any of the preceding claims wherein the maximum extent of the object is less than 200 micrometers.

9. Apparatus according to any of the preceding claims wherein the maximum extent of the object is under 90 micrometers.

10. Apparatus according to any of the preceding claims wherein the maximum extent of the object is under 50 micrometers.

11. Apparatus according to any of the preceding claims wherein the maximum extent of the object is under 20 micrometers.

12. Apparatus according to any of the preceding claims wherein the maximum extent of the object is 10 micrometers.

13. Apparatus according to any of the preceding claims wherein the axle support surface is generally parallel to the substrate surface.

14. Apparatus according to any of the preceding claims wherein the axis of the axle is substantially parallel to the substrate surface.

15. Apparatus according to claim 14 wherein the object is a planar object whose planar surface is parallel to the axle.

16. Apparatus according to claim 15 wherein the planar object is adapted to be rotated from a first position at which one side of the object is visible to a second position at which a second side of the planar object is visible.

17. Micro-mechanical display apparatus comprising:
a plurality of pixels, each comprising an object according to claim 16.

18. Apparatus according to claim 17, wherein the planar object extends to a first extent on one side of the axis and extends to a lesser extent on a second side.

19. Apparatus according to claim 18 and including an electrifyable surface area on or in the substrate under at least a portion of the lesser extent.

20. Apparatus according claim 18 or claim 19 wherein the planar object is electrically conducting over at least a portion of its extent.

21. Apparatus according to claim 20 wherein the planar object is conducting over at least a portion of the lesser extent.

22. Micro-mechanical display apparatus, comprising:
a substrate;
a plurality of pixels on the substrate, each comprising:
a planar object; and
an axle, about which the planar object is rotatable, the planar object being adapted to be rotated from a first position at which one side of the object is visible to a second position at which a second side of the planar object is visible;
wherein:
the planar object extends past an axis of the axle, to a greater extent on one side and to a lesser extent on a second side thereof;
the planar object is conducting at least over a portion of the lesser extent, further comprising:
an electrifyable surface area on or in the substrate under at least a portion of the lesser extent.

23. Apparatus according to claim 22 and including at least one socket that at least partially constrains movement of the axle.

24. Apparatus according to any of claims 18-23 and including a source of electrical voltage that provides a non-zero voltage to said electrifyable surface area, to attract the lesser extent thereto, initiating rotation of the surface area.

25. Apparatus according to any of claims 18-24 and including at least one levitation electrode situated past the greater extent and above a resting position of the planar object, the at least one levitation electrode being electrifyable.

26. Apparatus according to claim 25 and including a controller that controls selective electrification of the electrifyable surface area and the levitation electrode to cause the planar element to flip from the first position to the second position;

27. Apparatus according to any of claims 18-26 and wherein at least a portion of the planar object near the axis on the portion of greater extent is either missing or non-conducting.

28. Apparatus according to any of claims 18-27 wherein the first face of the planar object is finished in a first manner and the second face of the panel is finished in a second manner.

29. Apparatus according to claim 28 wherein when the planar object is in the first position or the second position, a visible area on the far side of the axis is finished in a manner similar to the visible face of the planar object.

30. Apparatus according to claim 28 or claim 29 wherein the different finishes comprise different colors.

31. Apparatus according to any of the preceding claims wherein the object is comprised of polysilcon.

32. Apparatus according to claim 31 wherein the object is coated at least partially with another material

33. Apparatus according to any of the preceding claims wherein the axle is comprised of polysilicon.

34. Apparatus according to any of claims 1-29 wherein the object is comprised of a metal.

35. Apparatus according to claim 34 wherein the object is coated at least partially with another material

36. Apparatus according to any of claims 1-29, 34 or 35 wherein the axle is comprised of a metal.

37. Apparatus according to any of the preceding claims wherein the substrate is silicon.

38. Apparatus according to any of claims 1-36 wherein the substrate is glass.

39. Apparatus according to any of claims 1-36 wherein the substrate is flexible.

40. A method of forming a rounded cylindrical element, comprising:
(a) providing a rectangular cylindrical element of a first material that can be etched with a first etchant;
(b) coating at least some of the surfaces of the rectangular cylindrical element with a layer of a second material etchable with a second etchant and resistant to the first etchant;
(c) overcoating the second material with a third material, resistant to the first and second etchants, the third material being discontinuous at at least some corners of the cylindrical element;
(d) etching the second material with the second etchant, at the corners to remove a portion of the layer of second material adjacent the corners;
(e) etching the first material with the first etchant to remove a portion of the first material at the corner and under a portion of the remaining second material layer.

41. A method according to claim 40 including repeating (d) and (e) at least once.

42. A method according to claim 41 including repeating (d) and (e) a plurality of times.

43. A method according to any of claims 40-42 and including removing any remaining first and second materials.

44. A method according to any of claims 40-43 wherein the first material is polysilicon.

45. A method according to any of claims 40-44 wherein the second material is an oxide or glass layer.

46. A method according to any of claims 40-45 wherein the third material is silicon nitride.

47. A method according to any of claims 40-43 wherein the first material is a metal.

48. A method of flipping an object having an axle about which the object is generally rotatable, from a first position at which one area of the object is visible to a second position at which a second area of the object is visible, the object extending radially past an axis of the axle, to a greater extent on one side and to a lesser extent on a second side thereof, the method comprising:
constraining the panel from flipping;
providing an electric field to at least a portion of the lesser extent, in a direction that tends to move the panel from the first toward the second positions

49. A method according to claim 48 and including removing the constraint against flipping, such that the object flips from the first position to the second position.

50. A method according to claim 49 wherein constraining comprises electrifying an additional electrode and where removing the constraint comprises removing the electrification.

51. A method according to any of claims 48-50 wherein the object is conducting at least over a portion of the lesser extent.

52. A method according to any of the preceding claims wherein the object is a generally planar object and wherein one face of the planar object is visible in the first position and a second face of the object is visible in a second position.

53. A method according to claim 52 wherein the object is a generally rectangular panel.

54. A method according to claim 52 or claim 53 wherein the additional electrode is an electrode situated in a plane different from that of the planar object in the first position or the second position.

55. A method according to claim 54 wherein the additional electrode is situated below the plane of the first position.

56. A method according to claim 54 wherein the additional electrode is situated above the plane of the first position and to the side of the object when it is in the first position.

57. A method according to any of claims 48-56 wherein the object is comprised of polysilicon.

58. A method according to any of claims 48-56 wherein the object is comprised of a metal.

59. A method according to any of claims 48-58 wherein the object has a maximum dimension of less than 1 mm.
